(19) United States
(12) Patent Application Publication
(10) Pub. No.: US 2014/0169565 A1
(43) Pub. Date: Jun. 19, 2014

(54) METHODS, APPARATUS AND COMPUTER PROGRAMS FOR SCRAMBLING CODE SIGNALLING

(71) Applicant: BROADCOM CORPORATION, Irvine, CA (US)

(72) Inventors: Timo Eric ROMAN, Espoo (FI); Tommi Tapani KOIVISTO, Espoo (FI); Mihai Horatiu ENESCU, Espoo (FI); Karl Marko Juhani LAMPINEN, Oulu (FI)

(73) Assignee: BROADCOM CORPORATION, Irvine, CA (US)

(21) Appl. No.: 14/104,462

(22) Filed: Dec. 12, 2013

(30) Foreign Application Priority Data
Dec. 13, 2012 (GB) 1222510.8

(51) Int. Cl. H04W 12/08

(52) U.S. Cl. CPC H04W 12/08
USPC 380/270

(57) ABSTRACT

Methods, apparatus and computer readable storage media are provided herein for scrambling code signalling in support of interference cancelling receivers. In some example embodiments, a method is provided that includes receiving scrambling code initialization parameters for at least one wanted codeword and for at least one interfering codeword from a base station. The method of this embodiment may also include detecting the at least one wanted codeword and the at least one interfering codeword in a transmission that is received from a base station. The method of this embodiment may also include decoding the at least one wanted codeword and the at least one interfering codeword. In some example embodiments, the decoded at least one interfering codeword is used in at least one of interference detection or interference cancellation.

### CROSS REFERENCE TO RELATED APPLICATION

This application claims the benefit under 35 U.S.C. §119(a) and 37 CFR §1.55 to UK Patent Application No. 1222510.8, filed on Dec. 13, 2012, the entire content of which is incorporated herein by reference.

### FIELD OF THE INVENTION

The present invention relates to methods, apparatus and computer programs for scrambling code signalling. Embodiments of the present invention relate generally to communications technology and particular embodiments to example scrambling code signalling in support of interference cancelling receivers.

### BACKGROUND INFORMATION

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power provided only by the most advanced desktop computers. Consequently, mobile computing devices having a small form factor have become ubiquitous and are used by consumers of a wide range of socioeconomic backgrounds.

As a result of the expansion in computing power and the reduction in size of mobile computing devices, mobile computing devices are being constantly activated on networks that are already experiencing high levels of network density. Such network density, in some examples, results in increased interference levels at the mobile terminal. In order to address interference, current inter-cell interference mitigation techniques include, but are not limited to, coordinated multi-point transmission (CoMP) which is a transmitter-side technique used to manage interference. Interference may also be addressed using receiver-side techniques such as interference suppression which, in some examples, is based on the statistical properties on the interfering signal. Other receiver-side techniques include, but are not limited to, interference cancellation where an interfering signal is detected during or before performing a cancellation operation and/or the like.

### SUMMARY

According to a first aspect of the present invention, there is provided a method including: receiving scrambling code initialization parameters for at least one wanted codeword and for at least one interfering codeword; detecting the at least one wanted codeword in a transmission that is received from a base station; and decoding the at least one wanted codeword.

The method of this embodiment may also include decoding the at least one wanted codeword and the at least one interfering codeword using the signalled scrambling code initialization parameters, such that, in some examples, the mobile terminal may perform explicit detection and cancellation of the co-channel interference based on the scrambling code initialization parameters applied to the interfering signals.

According to a second aspect of the present invention, there is provided apparatus including: a processing system arranged to cause the apparatus to at least: receive scrambling code initialization parameters for at least one wanted codeword and for at least one interfering codeword; detect the at least one wanted codeword in a transmission that is received from a base station; and decode the at least one wanted codeword.

According to a third aspect of the present invention, there is provided a computer program including instructions which when executed by an apparatus cause the apparatus at least to: receive scrambling code initialization parameters for at least one wanted codeword and for at least one interfering codeword; detect the at least one wanted codeword in a transmission that is received from a base station; and decode the at least one wanted codeword.

According to a fourth aspect of the present invention, there is provided apparatus including: means for receiving scrambling code initialization parameters for at least one wanted codeword and for at least one interfering codeword; means for detecting the at least one wanted codeword in a transmission that is received from a base station; and means for decoding the at least one wanted codeword.

According to a fifth aspect of the present invention, there is provided a method including: generating scrambling code initialization parameters for at least one wanted codeword and for at least one interfering codeword; and causing the scrambling code initialization parameters to be transmitted to a mobile terminal, wherein the scrambling code initialization parameters are configured to enable the mobile terminal to perform at least one of interference detection or interference cancellation.

According to a sixth aspect of the present invention, there is provided apparatus including: a processing system arranged to cause the apparatus to at least: generate scrambling code initialization parameters for at least one wanted codeword and for at least one interfering codeword; and cause the scrambling code initialization parameters to be transmitted to a mobile terminal, wherein the scrambling code initialization parameters are configured to enable said mobile terminal to perform at least one of interference detection or interference cancellation.

According to a seventh aspect of the present invention, there is provided a computer program including instructions which when executed by an apparatus cause the apparatus at least to: generate scrambling code initialization parameters for at least one wanted codeword and for at least one interfering codeword; and cause the scrambling code initialization parameters to be transmitted to a mobile terminal, wherein the scrambling code initialization parameters are configured to enable the mobile terminal to perform at least one of interference detection or interference cancellation.

According to an eighth aspect of the present invention, there is provided apparatus including: means for generating scrambling code initialization parameters for at least one wanted codeword and for at least one interfering codeword; and means for causing the scrambling code initialization parameters to be transmitted to a mobile terminal, wherein the scrambling code initialization parameters are configured to enable said mobile terminal to perform at least one of interference detection or interference cancellation.

The processing systems described above may include at least one processor and at least one memory including computer program code, with the at least one memory and the computer program code being configured, with the at least one processor, to cause the apparatus at least to operate as described above.

There may be provided a computer program product that includes at least one non-transitory computer-readable storage medium having computer-readable program instructions as described above stored therein.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic representation of an example of a system having a mobile terminal that may benefit from some example embodiments of the present invention;

FIG. 2 shows a block diagram of an example of an apparatus that may be embodied by a mobile terminal and/or a base station in accordance with some example embodiments of the present invention;

FIG. 3 shows a flowchart illustrating operations performed by an example mobile terminal in accordance with some example embodiments of the present invention; and

FIG. 4 shows a flowchart illustrating operations performed by an example base station in accordance with some example embodiments of the present invention.

### DETAILED DESCRIPTION

The present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this specification, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in a server, a cellular network device, or other network device.

In some examples, mobile terminal-based advanced interference cancellation (IC) receivers that are performing co-channel detection may request or otherwise require information about the interfering signal to enable detection of the interfering symbols. In other examples, information about the interfering signal may also permit decoding of the actual bits in order to enable cancellation of the interference. Such information may include (e.g. based on the type of the SIC-receiver (successive interference cancellation receiver) operating on the mobile terminal), but is not limited to: resource allocation, modulation, modulation/coding scheme (MCS) information of the interfering stream, hybrid automatic repeat request (HARQ) redundancy version and/or the like. Additionally, in an instance in which demodulation reference signals (DM-RS) are used for demodulation, the mobile terminal may determine or otherwise detect the antenna ports for both the wanted and the interfering signals and/or the corresponding scrambling identifier (ID) for DM-RS sequence generation. In an instance in which common reference symbols (CRS) are used for demodulation, the mobile terminal may detect or otherwise determine the precoding matrix indication (PMI) information (e.g. wideband) for both the wanted and the interfering signals.

In some example embodiments, the mobile terminal-based IC receivers that are configured to detect, and in some examples decode, the at least one interfering codeword in addition to the at least one wanted codeword may include successive interference cancellation (SIC) receivers and variants thereof, such as but no limited to linear minimum square error (LMMSE) SIC involving a linear detection stage following by a non-linear SIC stage, maximum-likelihood (ML) SIC involving a non-linear ML detection stage followed by a non-linear SIC stage. Alternatively or additionally, ML receivers without an SIC stage, iterative turbo SIC receivers where post channel decoding soft bits information is used as a priori information and/or the other exemplary receiver structures may also need or otherwise benefit from the ability to detect, and in some examples decode, the at least one interfering codeword in addition to the at least one wanted codeword.

As is described herein, bit scrambling may be applied in cellular systems, such as Long Term Evolution (LTE) systems, to downlink physical channels as well as downlink reference symbols (e.g. CRS, CSI-RS, DM-RS or the like). Signal scrambling is configured to randomize intra- and/or inter-cell interference for data and control channels as well as reference symbols. In some examples, signal scrambling is applied at bit level on channel coded bits prior to modulation. For example, scrambling may be performed via an exclusive-or (XOR) type of logical operation which consists of adding modulo 2 at the bit level to the signal sequence to be scrambled with the scrambling sequence itself. In further examples, the scrambling sequence consists of a pseudo-random Gold sequence.

In some examples, the process of generating a scrambling sequence includes the use of two m-sequences, one of which is initialized in a predefined way and the other of which is initialized in a more dynamic way on a case by case basis depending on the application of the latter sequence. Examples of initialization consist of defining a polynomial Cᵢₙᵢₜ that includes 31 coefficients. Initialization may then be performed with a set of scrambling code initialization parameters, some of which are either pre-defined, signalled via higher layer (e.g. radio resource control (RRC) signalling), dynamically signalled over the physical downlink control channel (PDCCH) or over the enhanced physical downlink control channel (EPDCCH). Parameters such as the cell ID, radio network temporary identifier (RNTI) or a slot number can be considered as pre-defined as these are known to the mobile terminal. Some of these parameters are cell specific (e.g. cell ID) or mobile terminal specific (e.g. RNTI). However, parameters such as the scrambling ID (n_{SCID}) for DM-RS scrambling sequence generation are dynamically signalled over PDCCH or EPDCCH as part of the downlink grant information.

According to some examples, as long as the mobile terminal treats (e.g. statistically) intra- or inter-cell co-channel interference without explicitly decoding the underlying signals, the mobile terminal may not need to determine or otherwise detect the scrambling sequence of the interfering signal. In an instance in which an advanced IC receiver is used by the mobile terminal to target explicit decoding of the interfering signal, the scrambling sequences of the at least one interfering signal is determined or otherwise detected by the mobile terminal so that payload bits can be correctly extracted after channel decoding. However, current example scrambling sequence initialization definitions cause the mobile terminal to be unable, in some examples, to determine the scrambling sequences of the at least one interfering signal.

The method, apparatus and computer program product as described herein are configured to advantageously enable the mobile terminal to detect or to otherwise receive the scrambling sequence parameters so as to enable interference cancellation at the mobile terminal. In some example embodiments, scrambling sequence parameters for at least one interfering signal may be signalled to the mobile terminal in support of interference cancellation in addition to the scrambling sequence parameters of at least one wanted signal. In some examples, a portion of the signalling of a cell identifier, a transmission point identifier, an identifier of a channel state information reference signal (CSI-RS) or the like may be accomplished semi-statically via a higher layer (e.g. RRC). In some examples, the scrambling initialization component for each codeword may be accomplished dynamically over PDCCH, enhanced physical downlink control channel (EPDCCH) or the like. In further examples, signalling may be codeword specific.

In some example embodiments, the mobile terminal may be configured to receive the scrambling code initialization parameters for at least one wanted codeword and for at least one interfering codeword. The mobile terminal may then use the received scrambling code initialization parameters to generate a scrambling sequence that is operable to descramble the at least one wanted codeword and the at least one interfering codeword. The mobile terminal may then decode the at least one wanted codeword and the at least one interfering codeword. As such, the mobile terminal may then use the decoded at least one wanted codeword and at least one interfering codeword to improve successful detection probability for wanted codewords.

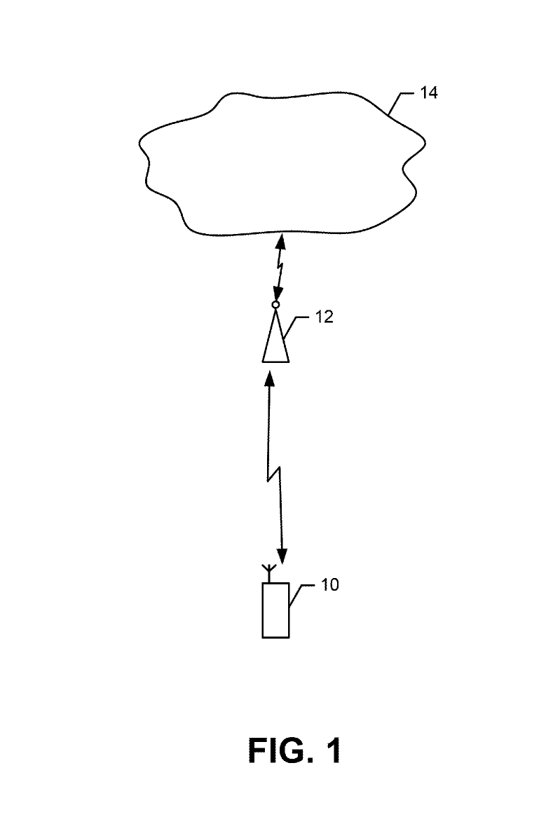

Although the method, apparatus and computer program product as described herein may be implemented in a variety of different systems, one example of such a system is shown schematically in FIG. 1, which shows a mobile terminal e.g. 10 that is capable of communication via a base station 12, such as a macro cell, a transmission point, a remote radio head, a Node B, an evolved Node B (eNB), Base Transceiver Station (BTS), a coordination unit, a macro base station or other base station, with a network 14 (e.g. a core network). While the network 14 may be configured in accordance with Global System for Mobile Communications (GSM), other networks, such as LTE™ or LTE-Advanced (LTE-A™), may support the method, apparatus and computer program product of some embodiments of the present invention including those configured in accordance with wideband code division multiple access (W-CDMA™), CDMA2000, General Packet Radio Service (GPRS™), IEEE™ 802.11 standard for wireless fidelity (WiFi), wireless local access network (WLAN™) Worldwide Interoperability for Microwave Access (WiMAX™) protocols, and/or the like.

The network 14 may include a collection of various different nodes, devices or functions that may be in communication with each other via corresponding wired and/or wireless interfaces. For example, the network 14 may include one or more cells, including base station 12, which may serve a respective coverage area. The base station 12 may be, for example, part of one or more cellular or mobile networks or public land mobile networks (PLMNs). In turn, other devices such as processing devices (e.g. personal computers, server computers or the like) may be coupled to the mobile terminal 10 and/or other communication devices via the network 14.

A mobile terminal, such as the mobile terminal 10 (also known as user equipment (UE), a communications device or the like), may be in communication with other mobile terminals or other devices via the base station 12 and, in turn, the network 14. In some cases, the mobile terminal 10 may include an antenna or a plurality of antennas for transmitting signals to and for receiving signals from a base station 12.

In some example embodiments, the mobile terminal 10 may be a mobile communication device such as, for example, a mobile telephone, portable digital assistant (PDA), pager, laptop computer, STA, a tablet, or any of numerous other hand held or portable communication devices, computation devices, content generation devices, content consumption devices, or combinations thereof. Other such devices that are configured to connect to the network include, but are not limited to, a refrigerator, a security system, a home lighting system, and/or the like. As such, the mobile terminal 10 may include one or more processors that may define processing circuitry and a processing system, either alone or in combination with one or more memories. The processing circuitry may utilize instructions stored in the memory to cause the mobile terminal 10 to operate in a particular way or execute specific functionality when the instructions are executed by the one or more processors. The mobile terminal 10 may also include communication circuitry and corresponding hardware/software to enable communication with other devices and/or the network 14.

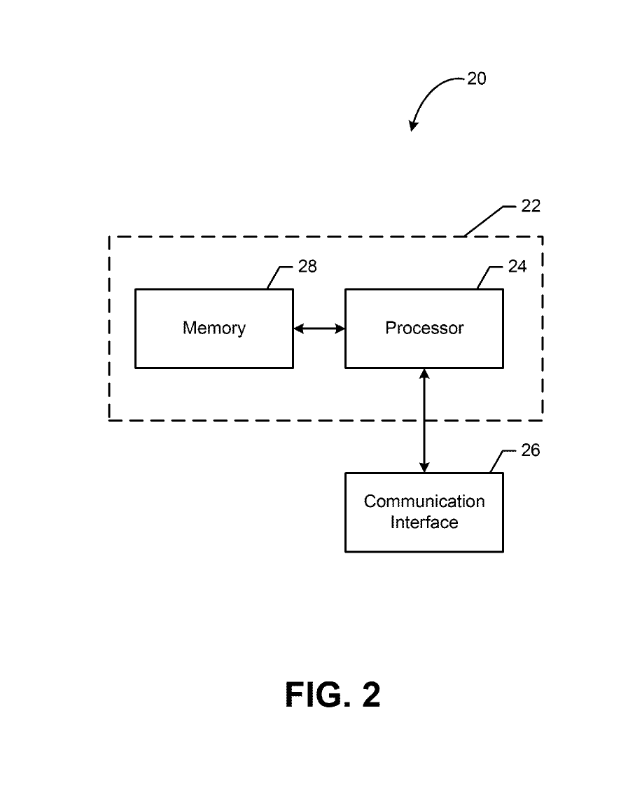

In some example embodiments, the mobile terminal 10 and/or the base station 12 may be embodied as or otherwise include an apparatus 20 as generically represented by the block diagram of FIG. 2. While the apparatus 20 may be employed, for example, by a mobile terminal 10 or a base station 12, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry 22 may be configured to perform data processing, application execution and/or other processing and management services according to an example embodiment of the present invention. In some embodiments, the apparatus or the processing circuitry may be embodied as a chip or chipset. In other words, the apparatus or the processing circuitry may include one or more physical packages (e.g. chips) including materials, components and/or wires on a structural assembly (e.g. a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip”. As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26. As such, the processing circuitry may be embodied as a circuit chip (e.g. an integrated circuit chip) configured (e.g. with hardware, software or a combination of hardware and software) to perform operations described herein. However, in some embodiments taken in the context of the mobile terminal 10, the processing circuitry may be embodied as a portion of a mobile computing device or other mobile terminal. In some examples, the processing circuitry 22 and/or the processor 24 may take the form of a processing system in some example embodiments.

The communication interface 26 may include one or more interface mechanisms for enabling communication with other devices and/or networks. In some cases, the communication interface may be any means such as a device or circuitry embodied in either hardware or a combination of hardware and software that is configured to receive and/or transmit data from/to a network 14 and/or any other device or module in communication with the processing circuitry 22, such as between the mobile terminal 10 and the base station 12. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor 24 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 24 may be configured to execute instructions stored in the memory 28 or otherwise accessible to the processor 24. As such, whether configured by hardware or by a combination of hardware and software, the processor 24 may represent an entity (e.g. physically embodied in circuitry, such as in the form of processing circuitry 22) capable of performing operations according to embodiments of the present invention while configured accordingly. Thus, for example, when the processor 24 is embodied as an ASIC, FPGA or the like, the processor 24 may be specifically configured hardware for conducting the operations described herein. Alternatively, as another example, when the processor 24 is embodied as an executor of software instructions, the instructions may specifically configure the processor 24 to perform the operations described herein.

In some example embodiments, and as is described herein, the base station 12, such as by the processing circuitry 22, the processor 24 or the like, is configured to modify the scrambling procedure for communications channels, such as physical downlink channels, in order to support advanced interference cancellation receivers that do perform explicit channel decoding to the interfering signal. In some examples, the scrambling procedure may be adapted for the physical downlink shared channel (PDSCH), while in other alternative embodiments such a procedure may be adapted for data-to-control IC, control-to-data. IC and/or the like.

In some example embodiments, the scrambling sequence (e.g. scrambling code initialization parameters) may be defined for each of the at least one wanted codeword and/or the at least one interfering codeword: for each codeword q, the block of bits b^{(q)}(0), . . . , b^{(q)}(M_{bit}^{(q)}−1) where M_{bit}^{(q)} is the number of hits in codeword q transmitted on the physical channel in one subframe is scrambled prior to modulation, resulting in a block of scrambled bits \tilde{b}^{(q)}(0), . . . , \tilde{b}(M_{bit}^{(q)}−1) according to:

\tilde{b}^{(q)}(i)=(b^{(q)}(i)+c^{(q)}(i))mod 2

where the scrambling sequence c^{(q)}(i) is defined by a length-31 Gold sequence or other pseudo-random sequence. In some examples, the scrambling sequence generator is initialized at the start of each subframe, where the initialization value of cᵢₙᵢₜ is, for example:

cᵢₙᵢₜ=n_{ICID}·2¹⁴+q·2¹³+└nₛ/2┘·2⁹+n_{ID}^{(k)}

In an example embodiment, the value of q may be signalled, such as by the communications interface 26 of the base station 12, for both the at least one wanted codeword and the at least one interfering codeword. For example, the at least one wanted codeword and the at least one interfering codeword may be assigned different scrambling sequences (e.g. for proper inter-/intra-cell interference randomization). Alternatively or additionally, joint signalling may also be used. For example, with rank-1 single codeword wanted signal and rank-1 single codeword interfering signal, q=0 for the wanted codeword may, for example, implicitly mean q=1 for the interfering codeword and/or vice versa.

In an example embodiment, in transmission modes using mobile terminal specific reference signals (RS), such as DM-RS, signalling of scrambling information for the at least one interfering signal may be tied together to at least one of the antenna port indication for the at least one interfering signal or the scrambling ID for the at least one interfering signal. For example, and with reference to the antenna port indication for the at least one interfering signal, if the mobile terminal is assigned antenna port 7 for demodulation of its own signal, q=0, and the interfering signal is decoded using antenna port 8 and q=1.

In an example embodiment, the value of q may be semi-statically signalled by the communication interface 26 of the base station 12 to the mobile terminal for each of the at least one wanted codewords. Semi-static signalling, in some examples, refers to RRC signalling on higher layers, indicating that the values can be changed but on large time intervals related typically to reconfiguration of the network connection. In LTE systems, semi-static signalling operates typically over a periodicity ranging from a few tens to a few hundreds of millisecond whereas dynamic signalling over PDCCH or EPDCCH may be performed on a TTI basis (i.e. every millisecond). As such and in some examples, static IC is permitted (e.g. in one cell codewords are always scrambled with a given set of q values while in the interfering cell codewords are always scrambled with another given set of q values orthogonal to the previous ones). In an example embodiment, the value of q is dynamically signalled over PDCCH/EPDCCH. As such, dynamic per-codeword initialization of scrambling is permitted by the base station 12 on a TTI basis, which may, for example, be beneficial because of less restricted scheduling by the base station 12.

In an example embodiment, n_{ICID} may refer to an interference cancellation identifier (ICID) and may further be semi-statically configured. In some examples, n_{ICID} may correspond to an identifier associated with the PDSCH transmission. In some examples, N_{ICID} may take the form of a component for scrambling code that is common to both the at least one wanted codeword and the at least one interfering codeword. The semi-statically configurable identifier may allow, for example, base stations to coordinate (e.g. via the X2 interface) in facilitating mobile terminal interference cancellation by grouping together mobile terminals into pools of terminals that may perform interference cancellation from one to another.

In an example embodiment, n_{ID}^{(k)} may be dynamically selected through the value of in the index k signalled, for example, over PDCCH, EPDCCH or the like. The set of possible values n_{ID}^{(k)}, k=0, . . . K−1 may be semi-statically configured (e.g. K being, for example, a predefined value for the maximum size for the set of n_{ID}^{(k)}) in some example embodiments.

In some example embodiments, a portion of the scrambling code initialization parameters may be derived from one or more available parameters, for example, relationships, system parameters such as the subframe index and/or the like.

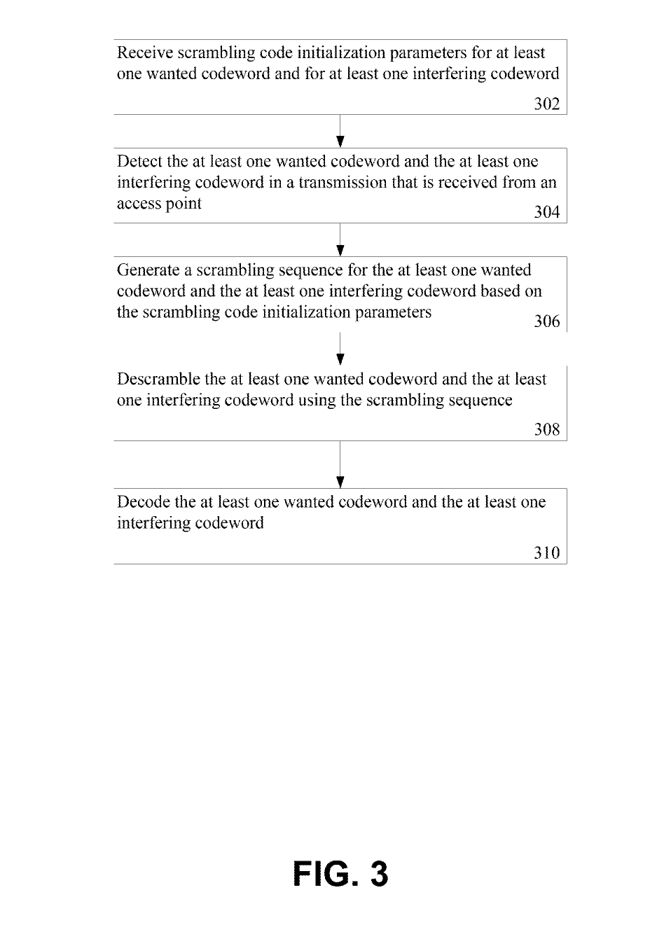

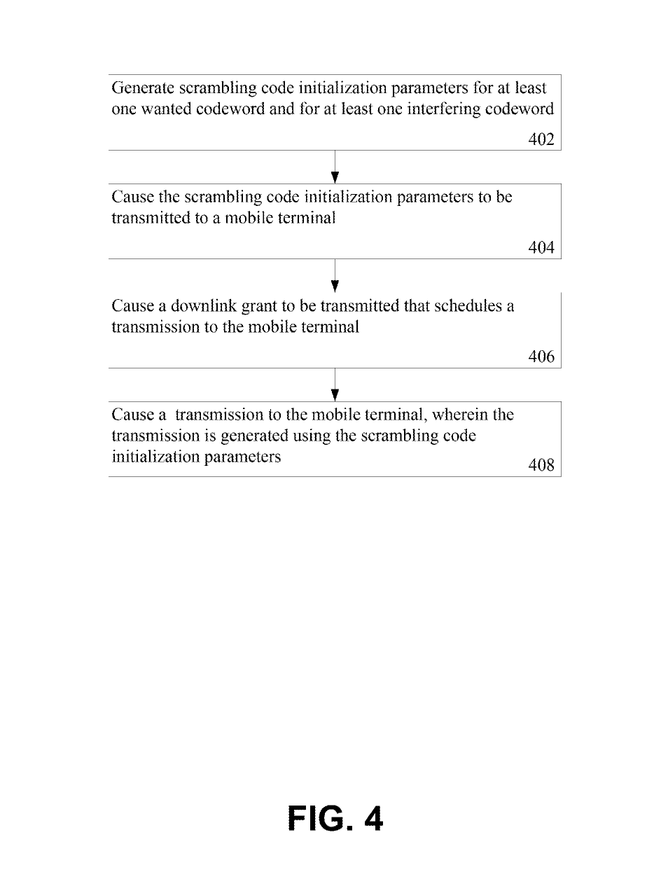

FIGS. 3 and 4 illustrate schematically example operations performed by a method, apparatus and computer program product, such as apparatus 20 of FIG. 2 in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described herein may be embodied by computer program instructions. In this regard, the computer program instructions which embody the procedures described herein may be stored by a memory 28 of an apparatus employing an embodiment of the present invention and executed by a processor 24 in the apparatus. As will be appreciated, any such computer program instructions may be loaded onto a computer or other programmable apparatus (e.g. hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 3 and 4, when executed, convert a computer or processing circuitry into a particular machine configured to perform an example embodiment of the present invention. Accordingly, the operations of FIGS. 3 and 4 define an algorithm for configuring a computer or processing circuitry 22, e.g. processing system, to perform an example embodiment. In some cases, a general purpose computer may be provided with an instance of the processor which performs the algorithm of FIGS. 3 and 4 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations herein either alone or in combination with any others among the features described herein.

FIG. 3 shows a flowchart illustrating operations performed by an example mobile terminal, such as mobile terminal 10, or a component of a mobile terminal, such as the processing circuitry 22, the processor 24, the communications interface 26, a modem and/or the like, in accordance with some example embodiments of the present invention. As is shown with respect to operation 302, the apparatus 20 embodied, for example, by mobile terminal 10, may include means, such as the processing circuitry 22, the processor 24, the communication interface 26 or the like, for receiving scrambling code initialization parameters (e.g. N_{ICID}, q, n_{ID}^{(k)}) for at least one wanted codeword and for at least one interfering codeword. In some example embodiments, the at least one wanted codeword and the at least one interfering codeword are PDSCH codewords. In some example embodiments, the scrambling code initialization parameters include a codeword-specific component for scrambling code initialization.

In some example embodiments, a first portion of the scrambling code initialization parameters are signalled semi-statically and a second portion of the scrambling code initialization parameters are signalled dynamically as are described herein. In further example embodiments, the scrambling code initialization parameters are tied to at least one of an antenna port indication for at least one interfering signal or a scrambling identification for the at least one interfering signal in an instance in which a transmission mode involving mobile terminal specific reference signal is used.

As is shown with respect to operation 304, the apparatus 20 embodied, for example, by mobile terminal 10, may include means, such as the processing circuitry 22, the processor 24, the communication interface 26 or the like, for detecting the at least one wanted codeword and the at least one interfering codeword in a transmission that is received from a base station. In some example embodiments, the mobile terminal receives and detects the at least one wanted codeword and the at least one interfering codeword at symbol level (e.g. through equalisation).

As is shown with respect to operation 306, the apparatus 20 embodied, for example, by mobile terminal 10, may include means, such as the processing circuitry 22, the processor 24 or the like, for generating a scrambling sequence for the at least one wanted codeword and the at least one interfering codeword based on the scrambling code initialization parameters.

As is shown with respect to operation 308, the apparatus 20 embodied, for example, by mobile terminal 10, may include means, such as the processing circuitry 22, the processor 24 or the like, for descrambling the at least one wanted codeword and the at least one interfering codeword using the scrambling sequence. In some example embodiments, the at least one wanted codeword and the at least one interfering codeword are descrambled at bit level.

As is shown with respect to operation 310, the apparatus 20 embodied, for example, by mobile terminal 10, may include means, such as the processing circuitry 22, the processor 24 or the like, for decoding the at least one wanted codeword and the at least one interfering codeword. In some example embodiments, the at least one wanted codeword and the at least one interfering codeword are decoded so as to improve successful detection probability for the at least one wanted codeword.

Alternatively or additionally, and in some example embodiments, the mobile terminal 10, may include means, such as the processing circuitry 22, the processor 24 or the like, for determining whether to detect, descramble and/or decode the at least one interfering codeword. As such, in some examples, the mobile terminal 10 may detect the at least one interfering codeword, but may not decode the at least one codeword or otherwise use the at least one interfering codeword for the purposes of interference cancellation.

FIG. 4 shows a flowchart illustrating operations performed by an example base station, such as base station 12, or a component of a base station, such as the processing circuitry 22, the processor 24, the communications interface 26, a modem and/or the like, in accordance with some example embodiments of the present invention. As is shown with respect to operation 402, the apparatus 20 embodied, for example, by base station 12, may include means, such as the processing circuitry 22, the processor 24, the communication interface 26 or the like, for generating scrambling code initialization parameters for at least one wanted codeword and for at least one interfering codeword.

In some example embodiments, a first portion of the scrambling code initialization parameters are signalled semi-statically and a second portion of the scrambling code initialization parameters are signalled dynamically. In some example embodiments, the base station 12, such as via the processing circuitry 22, the processor 24, the communication interface 26 or the like, may configure semi-statically (e.g. via RRC signalling), the first portion of the scrambling code initialization parameters. Whereas, a downlink grant over PDCCH or EPDCCH may include the second portion of second portion of the scrambling code initialization parameters.

In further example embodiments, the scrambling code initialization parameters are tied to at least one of an antenna port indication for at least one interfering signal or a scrambling identification for the at least one interfering signal in an instance in which a transmission mode involving mobile terminal-specific reference signal is used.

As is shown with respect to operation 404, the apparatus 20 embodied, for example, by base station 12, may include means, such as the processing circuitry 22, the processor 24, the communication interface 26 or the like, for causing the scrambling code initialization parameters to be transmitted to a mobile terminal, wherein the scrambling code initialization information is configured to enable the mobile terminal to perform interference cancellation.

As is shown with respect to operation 406, the apparatus 20 embodied, for example, by base station 12, may include means, such as the processing circuitry 22, the processor 24, the communication interface 26 or the like, for causing a downlink grant to be transmitted (e.g. over a physical downlink control channel) that schedules a transmission (e.g. physical downlink shared channel transmission) to the mobile terminal.

As is shown with respect to operation 408, the apparatus 20 embodied, for example, by base station 12, may include means, such as the processing circuitry 22, the processor 24, the communication interface 26 or the like, for causing a transmission (e.g. physical downlink shared channel transmission) to the mobile terminal, wherein the transmission (e.g. physical downlink shared channel transmission) is generated using the scrambling code initialization parameters.

In some example embodiments, the base station 12, such as via the processing circuitry 22, the processor 24, the communication interface 26 or the like, may coordinate scrambling parameter information with neighbouring base stations (e.g. via the X2 interface) using signalling exchange, for example, for signalling one or more of the scrambling code initialization parameters n_{ICID}, q, n_{ID}^{(k)} used by the base station in scrambling to another base station, such as for example PDSCH scrambling. In some examples, scrambling code initialization parameters may be received from one or more other base stations. In some examples, scrambling code initialization parameters may be transmitted to one or more other base stations. Advantageously, example coordination between base stations may enable interference mitigation between mobile terminals that cause interference to each other, but are not attached to the same base station. As such, the base stations may coordinate and may further mutually signal scrambling code parameters to associated mobile terminals so that the mobile terminals can efficiently cancel out the interference (e.g. via SIC processing).

Advantageously and in some examples, the methods, apparatus and computer program products described herein enable utilization of advanced receivers performing explicit detection and cancellation of the co-channel interference by providing information on the scrambling applied to interfering signals. Provision of information relating to the scrambling applied to interfering signals, in some examples, results in low signalling overhead and high scheduling flexibility. Alternatively or additionally, the method, apparatus and computer program product described herein, in some examples, applies to both CRS and DM-RS based transmission modes.

It is noted that initialization polynomials described herein are provided for illustrative purposes. There are numerous other possibilities for arranging initialization polynomial coefficients according to the principles proposed herein. Also, scrambling is herein applied at bit level after channel coding, however this is a non-limiting example, as the disclosure herein may be extended to other possible ways of performing scrambling (e.g. at symbols level, at un-coded bit level, etc.). As such, initialization of both desired signal and signal targeted by IC depends on signalled parameters where the signalling may be dynamic, semi-static or both.

The methods, apparatus and computer program products described herein may also be applied in instances in which the at least one wanted codeword and/or the at least one interfering codeword originate from one of the following non-exclusive listing: the same or different cells; the same or different transmission points; the same or different radio access technologies (e.g. OFDMA, SC-FDMA); the same or different radio link directions (e.g. uplink, downlink); the same or different networks entities (e.g. base station, another mobile terminal engaged in device-to-device communications); and/or the like. The methods, apparatus and computer program products described herein may also be applied to the case of transmission ranks higher than one for the wanted and/or the interfering codeword. For example, the initialization sequence may be provided as follows in some example embodiments:

cᵢₙᵢₜ=n_{ICID}·2¹⁵+q·2¹³+└nₛ/2┘·2⁹+n_{ID}^{(k)}

where q=0, 1, 2, 3 Such an example of initializing scrambling allows for a total of 4 codewords, e.g. up to 2 codewords for the wanted signal and up to 2 codewords for the interfering signal.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method comprising:
receiving scrambling code initialization parameters for at least one wanted codeword and for at least one interfering codeword;
detecting the at least one wanted codeword in a transmission that is received from a base station; and
decoding the at least one wanted codeword.

2. The method according to claim 1, further comprising at least one of:
a) detecting the at least one interfering codeword in the transmission that is received from the base station, and
decoding the at least one interfering codeword, wherein the decoded at least one interfering codeword is used in at least one of interference detection or interference cancellation;
b) generating scrambling sequences for the at least one wanted codeword based on the scrambling code initialization parameters, and
descrambling the at least one wanted codeword using the scrambling sequences generated for the at least one wanted codeword; and
c) generating scrambling sequences for the at least one interfering codeword based on the scrambling code initialization parameters, and
descrambling the at least one interfering codeword using the scrambling sequences generated for the at least one interfering codeword.

3. The method according to claim 1, wherein at least one of:
the scrambling code initialization parameters comprise a codeword-specific component for scrambling code initialization;
the scrambling code initialization parameters comprise a component for scrambling code initialization that is common to both the at least one wanted codeword and the at least one interfering codeword;
at least a portion of the scrambling code initialization parameters are signalled jointly for the at least one wanted codeword and the at least one interfering codeword;
a portion of the scrambling code initialization parameters are signalled semi-statically;
a portion of the scrambling code initialization parameters are signalled dynamically;
a portion of the scrambling code initialization parameters are derived from one or more available parameters;
the scrambling code initialization parameters are tied to at least one of an antenna port indication for at least one interfering signal or a scrambling identification for the at least one interfering signal in an instance in which a transmission mode involving a mobile terminal-specific reference signal is used; and
the at least one wanted codeword and the at least one interfering codeword are physical downlink shared channel codewords.

4. An apparatus comprising:
a processing system arranged to cause the apparatus to at least:
receive scrambling code initialization parameters for at least one wanted codeword and for at least one interfering codeword;
detect the at least one wanted codeword in a transmission that is received from a base station; and
decode the at least one wanted codeword.

5. The apparatus according to claim 4, wherein the processing system is arranged to cause the apparatus to at least one of:
a) detect the at least one interfering codeword in the transmission that is received from a said base station, and
decode the at least one interfering codeword, wherein the decoded at least one interfering codeword is used in at least one of interference detection or interference cancellation;
b) generate scrambling sequences for the at least one wanted codeword based on the scrambling code initialization parameters, and
descramble the at least one wanted codeword using the scrambling sequences generated for the at least one wanted codeword; and
c) generate scrambling sequences for the at least one interfering codeword based on the scrambling code initialization parameters, and
descramble the at least one interfering codeword using the scrambling sequences generated for the at least one interfering codeword.

6. The apparatus according to claim 4, wherein at least one of:
the scrambling code initialization parameters comprise a codeword-specific component for scrambling code initialization;
the scrambling code initialization parameters comprise a component for scrambling code initialization that is common to both the at least one wanted codeword and the at least one interfering codeword;
at least a portion of the scrambling code initialization parameters are signalled jointly for the at least one wanted codeword and the at least one interfering codeword;
a portion of the scrambling code initialization parameters are signalled semi-statically;
a portion of the scrambling code initialization parameters are signalled dynamically;
a portion of the scrambling code initialization parameters are derived from one or more available parameters;
the scrambling code initialization parameters are tied to at least one of an antenna port indication for at least one interfering signal or a scrambling identification for the at least one interfering signal in an instance in which a transmission mode involving a mobile terminal-specific reference signal is used; and
the at least one wanted codeword and the at least one interfering codeword are physical downlink shared channel codewords.

7. A non-transitory computer-readable storage medium comprising computer program code which when executed by a data processing system, causes the data processing system to:
receive scrambling code initialization parameters for at least one wanted codeword and for at least one interfering codeword;
detect the at least one wanted codeword in a transmission that is received from a base station; and
decode the at least one wanted codeword.

8. The non-transitory computer-readable storage medium according to claim 7, comprising instructions which when executed by the apparatus cause the apparatus at least to:
a) detect the at least one interfering codeword in the transmission that is received from a said base station, and
decode the at least one interfering codeword, wherein the decoded at least one interfering codeword is used in at least one of interference detection or interference cancellation;
b) generate scrambling sequences for the at least one wanted codeword based on the scrambling code initialization parameters,
descramble the at least one wanted codeword using the scrambling sequences generated for the at least one wanted codeword; and
c) generate scrambling sequences for the at least one interfering codeword based on the scrambling code initialization parameters, and
descramble the at least one interfering codeword using the scrambling sequences generated for the at least one interfering codeword.

9. The non-transitory computer-readable storage medium according to claim 7, wherein at least one of:
the scrambling code initialization parameters comprise a codeword-specific component for scrambling code initialization;
the scrambling code initialization parameters comprise a component for scrambling code initialization that is common to both the at least one wanted codeword and the at least one interfering codeword;
at least a portion of the scrambling code initialization parameters are signalled jointly for the at least one wanted codeword and the at least one interfering codeword;
a portion of the scrambling code initialization parameters are signalled semi-statically;
a portion of the scrambling code initialization parameters are signalled dynamically;
a portion of the scrambling code initialization parameters are derived from one or more available parameters;
the scrambling code initialization parameters are tied to at least one of an antenna port indication for at least one interfering signal or a scrambling identification for the at least one interfering signal in an instance in which a transmission mode involving a mobile terminal-specific reference signal is used; and
the at least one wanted codeword and the at least one interfering codeword are physical downlink shared channel codewords.

10. A method comprising:
generating scrambling code initialization parameters for at least one wanted codeword and for at least one interfering codeword; and
causing the scrambling code initialization parameters to be transmitted to a mobile terminal, wherein the scrambling code initialization parameters are configured to enable the mobile terminal to perform at least one of interference detection or interference cancellation.

11. The method according to claim 10, wherein at least one of:
the scrambling code initialization parameters comprise a codeword-specific component for scrambling code initialization;
the scrambling code initialization parameters comprise a component for scrambling code initialization that is common to both the at least one wanted codeword and the at least one interfering codeword;
at least a portion of the scrambling code initialization parameters are signalled jointly for the at least one wanted codeword and the at least one interfering codeword;
a portion of the scrambling code initialization parameters are signalled semi-statically;
a portion of the scrambling code initialization parameters are signalled dynamically;
a portion of the scrambling code initialization parameters are derived from one or more available parameters;
the scrambling code initialization parameters are tied to at least one of an antenna port indication for at least one interfering signal or a scrambling identification for the at least one interfering signal in an instance in which a transmission mode involving a mobile terminal-specific reference signal is used;
the scrambling code initialization parameters are generated based on a coordination with a base station; and
the at least one wanted codeword and the at least one interfering codeword are physical downlink shared channel codewords.

12. The method according to claim 10, further comprising:
causing a downlink grant to be transmitted over a physical downlink control channel that schedules a physical downlink shared channel transmission to the mobile terminal;
causing the scheduled physical downlink shared channel transmission to be transmitted to the mobile terminal, wherein the physical downlink shared channel transmission is generated using the scrambling code initialization parameters;
causing scrambling code initialization parameters to be transmitted to said base station; and
receiving scrambling code initialization parameters from said base station.

13. An apparatus comprising:
a processing system arranged to cause the apparatus to at least:
generate scrambling code initialization parameters for at least one wanted codeword and for at least one interfering codeword; and
cause the scrambling code initialization parameters to be transmitted to a mobile terminal, wherein the scrambling code initialization parameters are configured to enable said mobile terminal to perform at least one of interference detection or interference cancellation.

14. The apparatus according to claim 13, wherein at least one of:
the scrambling code initialization parameters comprise a codeword-specific component for scrambling code initialization;
the scrambling code initialization parameters comprise a component for scrambling code initialization that is common to both the at least one wanted codeword and the at least one interfering codeword;
at least a portion of the scrambling code initialization parameters are signalled jointly for the at least one wanted codeword and the at least one interfering codeword;
a portion of the scrambling code initialization parameters are signalled semi-statically;
a portion of the scrambling code initialization parameters are signalled dynamically;
a portion of the scrambling code initialization parameters are derived from one or more available parameters; and
the scrambling code initialization parameters are tied to at least one of an antenna port indication for at least one interfering signal or a scrambling identification for the at least one interfering signal in an instance in which a transmission mode involving a mobile terminal-specific reference signal is used.

15. The apparatus according to claim 13, wherein at least one of:
the processing system is arranged to cause the apparatus to:
cause a downlink grant to be transmitted over a physical downlink control channel that schedules a physical downlink shared channel transmission to a said mobile terminal; and
cause the scheduled physical downlink shared channel transmission to be transmitted to a said mobile terminal, wherein the physical downlink shared channel transmission is generated using the scrambling code initialization parameters;
the scrambling code initialization parameters are generated based on a coordination with a base station;
the at least one wanted codeword and the at least one interfering codeword are physical downlink shared channel codewords; and
the apparatus comprises at least one of a base station, a node B or an enhanced node B.

16. A non-transitory computer-readable storage medium comprising computer program code which when executed by a data processing system, causes the data processing system to:
generate scrambling code initialization parameters for at least one wanted codeword and for at least one interfering codeword; and
cause the scrambling code initialization parameters to be transmitted to a mobile terminal, wherein the scrambling code initialization parameters are configured to enable the mobile terminal to perform at least one of interference detection or interference cancellation.

17. The non-transitory computer-readable storage medium according to claim 16, wherein at least one of:
the scrambling code initialization parameters comprise a codeword-specific component for scrambling code initialization;
the scrambling code initialization parameters comprise a component for scrambling code initialization that is common to both the at least one wanted codeword and the at least one interfering codeword;
at least a portion of the scrambling code initialization parameters are signalled jointly for the at least one wanted codeword and the at least one interfering codeword;
a portion of the scrambling code initialization parameters are signalled semi-statically;
a portion of the scrambling code initialization parameters are signalled dynamically;
a portion of the scrambling code initialization parameters are derived from one or more available parameters; and
the scrambling code initialization parameters are tied to at least one of an antenna port indication for at least one interfering signal or a scrambling identification for the at least one interfering signal in an instance in which a transmission mode involving a mobile terminal-specific reference signal is used.

18. The non-transitory computer-readable storage medium according to claim 16, further comprising instructions which when executed by said data processing system cause the data processing system to at least one of:
cause a downlink grant to be transmitted over a physical downlink control channel that schedules a physical downlink shared channel transmission to a said mobile terminal; and
cause the scheduled physical downlink shared channel transmission to be transmitted to a said mobile terminal, wherein the physical downlink shared channel transmission is generated using the scrambling code initialization parameters.

19. The non-transitory computer-readable storage medium according to claim 18, wherein the downlink grant is transmitted over a physical downlink control channel or an enhanced physical downlink control channel.

20. The non-transitory computer-readable storage medium according to claim 16, wherein at least one of:
the scrambling code initialization parameters are generated based on a coordination with a base station; and
the at least one wanted codeword and the at least one interfering codeword are physical downlink shared channel codewords.
